(19) United States
(12) Patent Application Publication
(10) Pub. No.: US 2025/0222788 A1
(43) Pub. Date: Jul. 10, 2025

(54) Supercapacitor Pack for a Vehicle Having a Battery Power Source

(71) Applicant: Hessner Technologies Limited, Hong Kong (HK)

(72) Inventors: Donald Allan Gray, Winnipeg (CA); Christian Daigneault, Hong Kong (HK); Clayton Lawrence Gray, Hong Kong (HK)

(21) Appl. No.: 18/973,402

(22) Filed: Dec. 9, 2024

Related U.S. Application Data
(60) Provisional application No. 63/618,420, filed on Jan. 8, 2024.

(51) Int. Cl. B60L 50/40; B60K 1/04; B60L 50/60; H01G 11/10; H01G 11/78; H01G 17/00; H01M 10/42; H01M 10/613; H01M 10/625; H01M 10/6561; H01M 50/204; H01M 50/249; H01M 50/271; H01M 50/284; H01M 50/30

(52) U.S. Cl. CPC B60L 50/40; B60K 1/04; B60L 50/66; H01G 11/10; H01G 11/78; H01G 17/00; H01M 10/4264; H01M 10/613; H01M 10/625; H01M 10/6561; H01M 50/204; H01M 50/249; H01M 50/271; H01M 50/284; H01M 50/30; B60L 2200/22; H01M 2220/20

(57) ABSTRACT

A supercapacitor pack is provided for a vehicle having a power source comprising a battery pack accommodated in a battery pack housing of the vehicle. The supercapacitor pack comprises a housing having means for attaching the supercapacitor pack to the battery pack housing such that a surface of the supercapacitor pack housing contacts a surface of at least one battery of the battery pack to secure or at least stabilize the position of the at least one battery relative to the battery pack housing. The supercapacitor pack housing has an interior space accommodating one or more supercapacitor devices. The one or more supercapacitor devices are electrically connected to an electrical port provided on the supercapacitor pack housing. This enables the supercapacitor pack to be electrically easily connected to the battery pack of the vehicle.

### CROSS-REFERENCE TO RELATED APPLICATIONS

This application claims priority to U.S. Provisional Application No. 63/618,420 filed Jan. 8, 2024, which is incorporated herein by reference.

### FIELD OF THE INVENTION

The invention relates to a supercapacitor pack for a vehicle having a power source comprising a battery pack. The invention relates particularly, but not exclusively, to electric powered vehicles and to providing a supercapacitor pack for extending the life of the vehicle battery pack.

### BACKGROUND OF THE INVENTION

Vehicles having a battery pack as a power source, especially vehicles having a battery pack for providing motive force, are very common. Such vehicles may exclusively rely on the battery pack as the sole power source for motive force, but may comprise hybrid vehicles which combine a battery pack power source with another power source such as an internal combustion engine.

Battery pack power sources store energy as chemical energy which is advantageously a stable form of storing energy without significant loss over long periods of time. However, battery pack power sources have some limitations. The battery packs typically work optimally within a limited temperature range of minus 20° C. to plus 40° C. This is effective for most operating environments, but not all. Lower operating environmental temperatures reduce chemical-reaction activity resulting in lower power and energy capabilities. In contrast, higher operating environmental temperatures can lead to thermal runaway resulting in overheating and even explosion of battery packs. Another limitation of battery packs is that repeated recharging of the battery pack leads in time to aging and potential failure of the battery pack necessitating the need to replace the battery pack or some or all of the batteries comprising the battery pack. This can be expensive especially in the case of electric vehicles (EVs) where the cost of a replacement battery pack may cost almost as much as the cost of a new vehicle. A further limitation of battery packs is that they may struggle to deliver energy quickly, particularly where energy is required in short power pulses or bursts such as the commencement of movement of vehicles or acceleration of vehicles.

Supercapacitors may be used in conjunction with battery packs to provide energy in short power pulses or bursts thereby relieving stress on the battery pack. However, the combination of supercapacitor packs with battery packs typically requires engineering and design tradeoffs. One of the challenges is finding the physical space to install both battery packs and capacitor packs and how to electrically connect the supercapacitor packs conveniently to the battery packs.

What is desired among other things therefore is an improved arrangement of a power source for a vehicle comprising a combination of a battery pack and a supercapacitor pack.

### OBJECTS OF THE INVENTION

An object of the invention is to mitigate or obviate to some degree one or more problems associated with known vehicles having a power source comprising or including a battery pack.

The above object is met by the combination of features of the main claims; the sub-claims disclose further advantageous embodiments of the invention.

Another object of the invention is to provide a novel means and/or method of extending the life of a vehicle battery pack.

A further object is to provide a supercapacitor pack for a vehicle having a power source comprising or including a battery pack.

A yet further object of the invention is to provide a method of modifying an existing vehicle having a power source comprising or including a battery pack to extend the life of the battery pack.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a vehicle comprising: a power source comprising a battery pack, the battery pack having at least one battery; a battery pack housing accommodating the battery pack; and a bracket for stabilizing a position of the at least one battery of the battery pack in the battery pack housing. The bracket has means for attaching the bracket to the battery pack housing such that a surface of the bracket contacts a surface of the at least one battery to secure or at least stabilize the position of the at least one battery relative to the battery pack housing. The bracket comprises a housing having an interior space, the interior space accommodating a supercapacitor pack with the supercapacitor pack electrically connected to the battery pack to thereby extend the life of the battery pack.

In a second main aspect, the invention provides a bracket for a vehicle having a power source comprising a battery pack accommodated in a battery pack housing. The bracket comprises: means for attaching the bracket to the battery pack housing of the vehicle such that a surface of the bracket contacts a surface of at least one battery of the battery pack to secure or at least stabilize the position of the at least one battery relative to the battery pack housing. The bracket comprises a housing having an interior space, the interior space configured to accommodate a supercapacitor pack, the supercapacitor pack electrically connectable to an electrical port provided on the housing, the electrical port enabling the supercapacitor pack to be electrically connected to the battery pack of the vehicle.

In a third main aspect, the invention provides a supercapacitor pack for a vehicle having a power source comprising a battery pack accommodated in a battery pack housing. The supercapacitor pack comprises: a housing, said housing having means for attaching the supercapacitor pack to the battery pack housing of the vehicle such that a surface of the housing contacts a surface of at least one battery of the battery pack to secure or at least stabilize the position of the at least one battery relative to the battery pack housing. The supercapacitor pack housing has an interior space, the interior space accommodating one or more supercapacitor devices comprising the supercapacitor pack, the one or more supercapacitor devices being electrically connected to an electrical port provided on the housing enabling the supercapacitor pack to be electrically connected to the battery pack of the vehicle.

In a fourth main aspect, the invention provides a method of extending the life of a battery pack of a vehicle, the battery pack being accommodated in a battery pack housing of the vehicle, the battery pack having at least one battery. The method comprises: attaching a bracket to the battery pack housing such that a surface of the bracket contacts a surface of the at least one battery to secure or at least stabilize the position of the at least one battery relative to the battery pack housing; providing a supercapacitor pack in an interior space of the bracket; and electrically connecting the supercapacitor pack to the battery pack.

In a fifth main aspect, the invention provides a method of modifying an existing vehicle having a battery pack accommodated in a battery pack housing of the vehicle, the battery pack having at least one battery, and a bracket for stabilizing a position of the at least one battery of the battery pack in the battery pack housing, the bracket having means for attaching the bracket to the battery pack housing such that a surface of the bracket contacts a surface of the at least one battery to secure or at least stabilize the position of the at least one battery relative to the battery pack housing; the method comprising: replacing the existing bracket by a bracket comprising a housing with an interior space, the interior space accommodating a supercapacitor pack; and electrically connecting the supercapacitor pack to the battery pack.

In a sixth main aspect, the invention provides a golf cart. The golf cart comprises: a power source comprising a battery pack, the battery pack having a plurality of batteries electrically connected in series; a battery pack housing accommodating the battery pack; and one or more brackets for stabilizing positions of the plurality of batteries of the battery pack in the battery pack housing, each bracket having means for attaching the bracket to the battery pack housing such that a lower surface of the bracket presses on portions of upper surfaces of at least two or more of the plurality of batteries to secure or at least stabilize the positions of the at least two or more of the plurality of batteries relative to the battery pack housing; wherein at least one of the brackets comprises a housing having an interior space, the interior space accommodating a supercapacitor pack, the supercapacitor pack electrically connected in parallel to the battery pack, the supercapacitor pack comprising a plurality of identical supercapacitor devices; wherein the bracket housing having an interior space accommodating a supercapacitor pack has a plurality of cylindrically shaped sections formed in the interior space to respectively accommodate the supercapacitor devices, the sections in the interior space of the bracket housing being shaped to be complimentary to a cylindrical outer shape of the supercapacitor devices and of a same size as the cylindrical outer shape of the supercapacitor devices; and wherein the bracket housing having an interior space accommodating a supercapacitor pack is sized to fit within a space on the portions of the upper surfaces of the at least two or more of the plurality of batteries where a maximum size of said space is delimited by positions of vent caps on the upper surfaces of the at least two or more of the plurality of batteries.

The summary of the invention does not necessarily disclose all the features essential for defining the invention; the invention may reside in a sub-combination of the disclosed features.

The forgoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic diagram of a golf cart by way of example of a vehicle in which the aspects of the invention can be implemented;

FIG. 2 is a schematic diagram comprising a view from above of a battery pack housing or compartment of a vehicle including a battery position stabilizing bracket in accordance with the invention;

FIG. 3 is a another view from above of a battery pack housing or compartment of a vehicle including a battery position stabilizing bracket in accordance with the invention;

FIG. 4 is a perspective view of a battery position stabilizing bracket or a supercapacitor pack in accordance with the invention;

FIG. 5 is a view from above of the battery position stabilizing bracket or the supercapacitor pack of FIG. 4;

FIG. 6 is a view from below of the battery position stabilizing bracket or the supercapacitor pack of FIG. 4;

FIG. 7 is a perspective view of sections of a bottom housing shell (half) and a top housing shell (half) comprising a housing for the battery position stabilizing bracket or the supercapacitor pack in accordance with one embodiment of the invention; and

FIG. 8 is a perspective view of the bottom housing shell of the housing for the battery position stabilizing bracket or the supercapacitor pack including a plurality of supercapacitor devices in accordance with one embodiment of the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

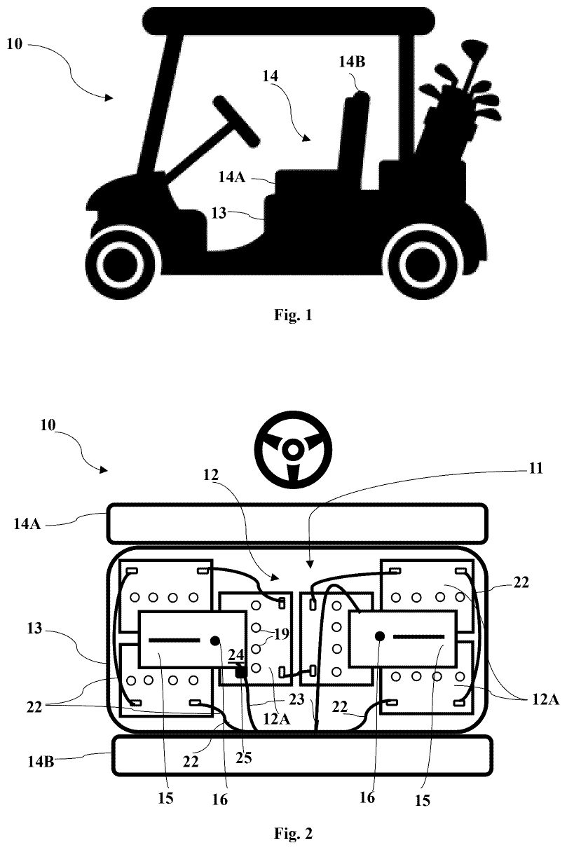

Referring to FIGS. 1 to 3, shown is a schematic diagram of a golf cart 10 by way of an example of a vehicle in which the aspects of the invention can be implemented. The following description of aspects of the invention will be provided with respect to the golf cart 10 of FIG. 1, but it will be appreciated that the aspects of the invention may be implemented in any vehicle 10 having a battery power pack and a battery bracket arrangement similar to that as hereinafter described.

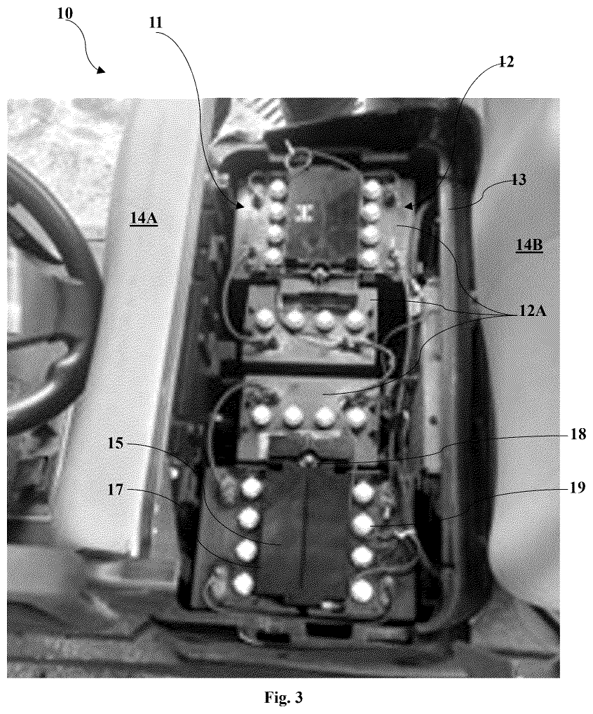

The golf cart 10 comprises a wheeled vehicle, but the vehicle could instead comprise caterpillar treads, tank treads, or rollers. The vehicle may comprise a three-wheeled vehicle. The golf cart 10 comprises a power source 11 comprising a battery pack 12 (FIG. 2). The power source 11 preferably provides power to generate motive force for the golf cart 10, but the power source 11 may also provide power for other functions of the vehicle. The battery pack 12 is accommodated in a battery pack housing or compartment 13, as better seen, in FIGS. 2 and 3. Reference herein to a battery pack housing 13 should be taken as a reference to a battery pack compartment 13 and vice-versa. The battery pack compartment 13 is located under a seat 14 of the golf cart 10, although this is not essential. However, it is typical for the battery pack compartment 13 to be located under the seat 14 of a golf cart 10 as it provides an easily accessible and convenient space for accommodating the battery pack 12. A main seat cushion 14A may be pivoted upwardly with respect to a seat backrest 14B to uncover the battery pack compartment 13.

It will be appreciated that, in some embodiments, the power source 11 may comprise only the battery pack 12 modified in accordance with the invention, but, in other embodiments, the power source 11 may comprise a hybrid power source comprising the battery pack 12 modified in accordance with the invention operating in combination with another power source such as, but not limited to, an internal combustion engine (not shown).

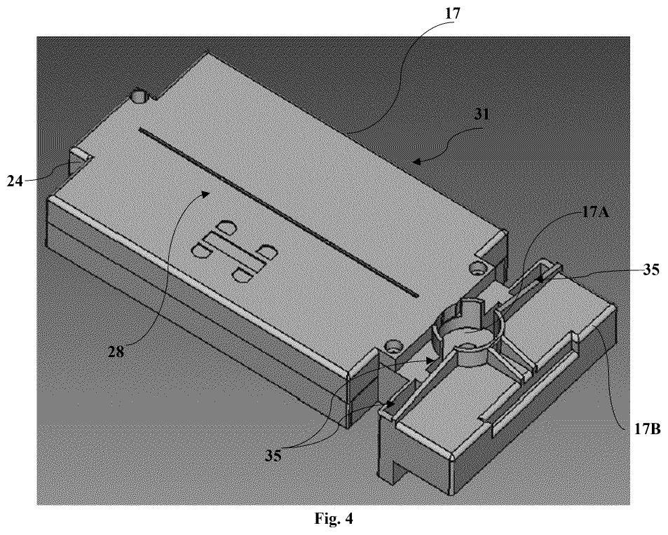

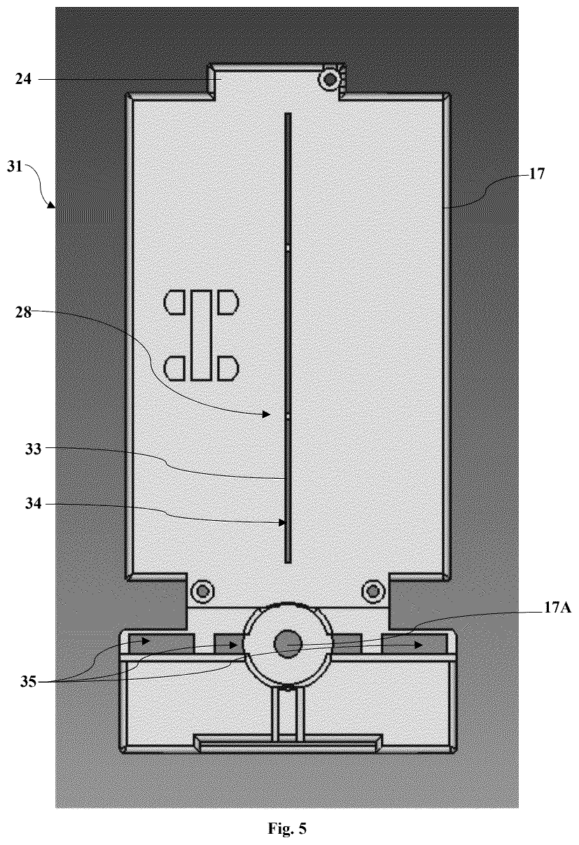

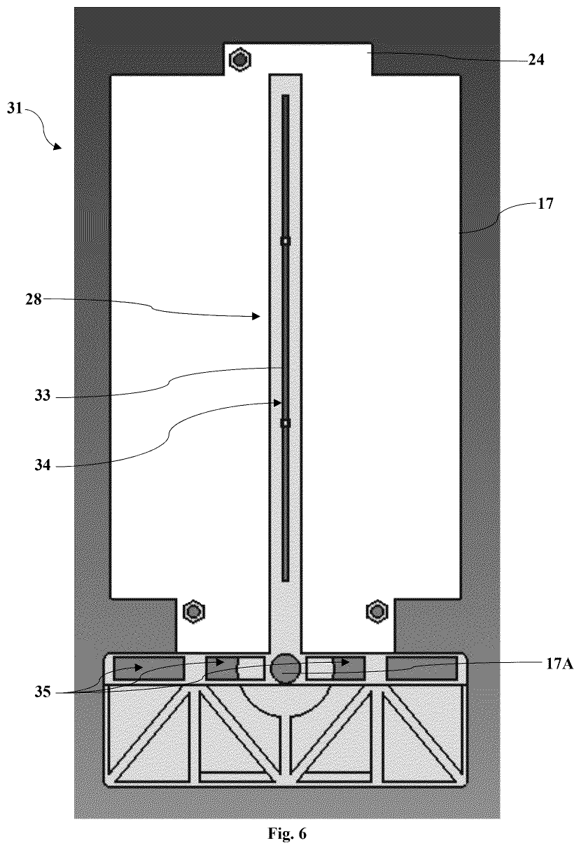

The battery pack 12 comprises at least one battery 12A, but preferably comprises a plurality of batteries 12A. A bracket 15 is provided for stabilizing a position of the at least one battery 12A in the battery pack compartment 13. The bracket 15 has means 16 for attaching the bracket 15 to the battery pack compartment 13 such that a surface of the bracket 15 contacts a surface of the at least one battery 12A to secure or at least stabilize the position of the at least one battery 12A relative to the battery pack compartment 13. The attachment means 16 may, in some embodiments, comprise an aperture 17A (FIG. 4) in a housing 17 of the bracket 15 through which a bolt 18 may be inserted with the bolt 18 screw-threadedly engaging a threaded hole provided in a base plate or the like of the battery pack compartment 13. The aperture 17A is preferably located along a longitudinal center line of the bracket housing 17 and spaced inwardly from one end edge 17B of the housing 17. The aperture 17A is preferably located sufficiently inwardly of said one end edge 17B of the housing 17 such that, when the bolt 18 is screw-threadedly engaged in the threaded hole provided in the base plate of the battery pack compartment 13 and the bolt 18 is then tightened, respective portions of a lower plane surface of the bracket 15 press downwardly on corresponding upper surface portions of at least two batteries 12A of the battery pack 12 to thereby stabilize the positions of the at least two batteries 12A relative to the battery pack compartment 13.

In the exemplary embodiment of the invention shown in FIGS. 2 and 3, the battery pack 12 comprises six batteries 12A arranged in an “I-shaped” configuration with two brackets 15, each bracket 15 being arranged to stabilize the positions of three of the six batteries 12A. In this embodiment, the battery pack 12 comprises six 8 volt flooded lead acid batteries 12A connected via their terminal electrodes in series by cables 22 to provide an output voltage of 48 volts. However, the batteries 12A may comprise lithium ion batteries, absorbent glass mat (AGM) batteries, or AES batteries. The flooded lead acid batteries 12A include vent caps 19 in a known manner and these are typically arranged as shown along longitudinal center lines of the batteries 12A.

The housing 17 of each bracket 15 is preferably sized so as to fit in a space above its respective three batteries 12A, said space delimited by the respective vent caps 19 of said batteries 12A. Preferably, the housing 17 of each bracket 15 is sized to provide sufficient clearance between side and end surfaces of the housing 17 so as to enable the vent caps 19 of the batteries 12A to be manually operated without hindrance or impedance.

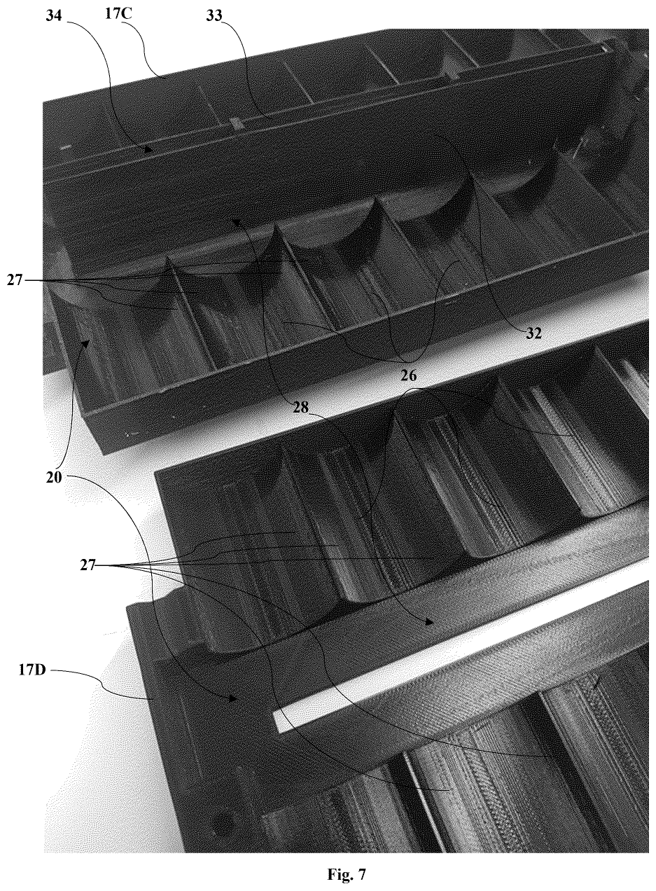

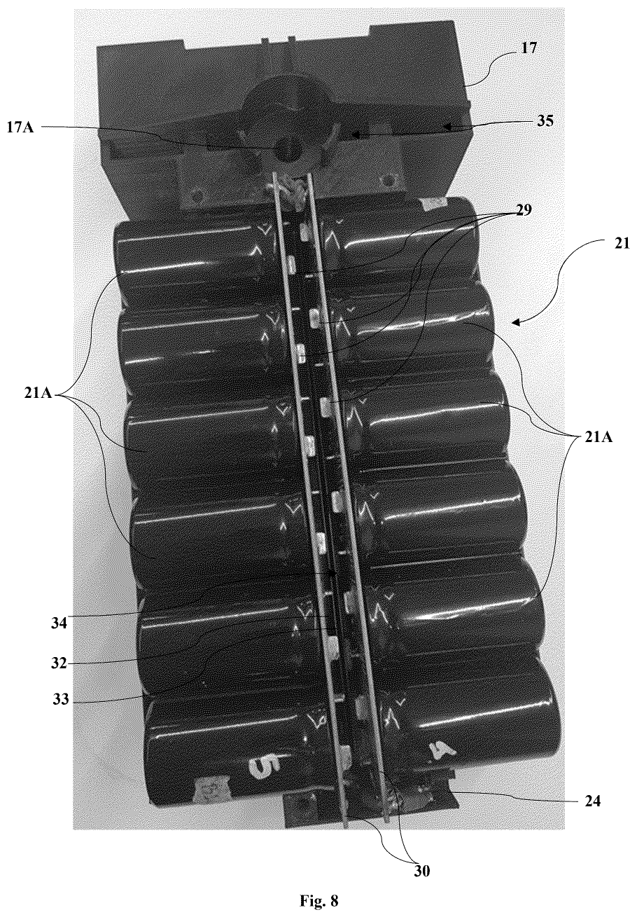

The housing 17 of each bracket 15 comprises an interior space 20 (FIGS. 7 and 8). The interior space 20 of each bracket 15 accommodates a supercapacitor pack 21 (FIG. 8).

Whilst the description herein refers to the interior space 20 of each bracket 15 accommodating a supercapacitor pack 21, it will be appreciated that, in some embodiments, only one of the brackets 15 includes a supercapacitor pack 21. In this case, the remaining bracket not including a supercapacitor pack 21 may comprise a conventional bracket, i.e., it may comprise a bracket that has not been configured in accordance with the present invention. In the case where an existing vehicle 10 is being modified to include one modified bracket 15 in accordance with the invention, only one of the conventional brackets need be replaced by the bracket 15 modified in accordance with the present invention.

The supercapacitor pack 21 of each bracket 15 is electrically connected, in use, to the battery pack 12. Preferably, each supercapacitor pack 21 of each bracket 15 is electrically connected in parallel by cables 23 to the battery pack 12. Each supercapacitor pack 21 preferably comprises a plurality of supercapacitor elements or devices 21A. However, in some embodiments, the supercapacitor pack 21 may comprise only one supercapacitor element or device 21A.

Preferably, the housing 17 of each bracket 15 has a connector port 24 and the plurality of supercapacitor elements or devices 21A of the supercapacitor pack 21 are electrically connected internally within the housing 17 to the connector port 24. The supercapacitor pack 21 can then be easily electrically connected, in use, to the battery pack 12 via the cable 23.

The bracket housing 17 is preferably a sealed housing 17 rendering it waterproof or at least water resistant. A grommet 25 may be provided with cable 23 to seal off the connector port 24 from the exterior of the housing 17.

Referring to FIG. 7, the bracket housing 17 is formed from a housing bottom shell or half 17C and a housing top shell or half 17D which, when joined together, define the interior space 20 of the bracket housing 17. The bottom shell 17C and the top shell 17D may be formed by 3D printing, by molding, or by any suitable manufacturing process. Preferably, the bottom shell 17C and the top shell 17D are formed from plastics materials. Preferably further, the bottom shell 17C and the top shell 17D are formed from thermally conductive plastics materials enabling the bracket housing 17 to shed heat.

The bottom shell 17C and the top shell 17D defining the interior space 20 of the bracket housing 17 each has one or more complementary sections or wells 26 separated by shoulders 27 to respectively accommodate one or more of the supercapacitor devices 21A comprising the supercapacitor pack 21. The one or more sections 26 and the shoulders 27 of the bottom shell 17C and the top shell 17D of the bracket housing 17 are each shaped to be complementary to an outer shape of the one or more supercapacitor devices 21A. In the exemplary embodiment of FIG. 7, the complementary sections 26 are half cylindrical in shape such that, when the bottom shell 17C and the top shell 17D of the bracket housing 17 are joined to form a sealed housing, the sections 26 and shoulders 27 define wells which are cylindrical in shape and are of a same size as an outer shape of the supercapacitor devices 21A to thereby firmly hold the supercapacitor devices 21A within the bracket housing 17.

In this embodiment, the complementary sections 26 of both the bottom shell 17C and the top shell 17D are therefore separated by concave shoulders 27. These are advantageous in that the concave shoulders 27 act not only to firmly position the supercapacitor devices 21A shielding said devices 21A from knocks, shocks or the like due to movement of the vehicle 10, but to strengthen the bracket housing 17. It will be understood that the bracket housing 17 must exhibit sufficient strength and robustness to function effectively as a battery position stabilizing bracket 15 in the manner described herein. Forming the bracket 15 to be largely hollow to define the interior space 20 weakens the structure of the bracket housing 17, but the provision of the shoulders 27 strengthens the bracket housing 17 to an extent which at least compensates for the loss of strength. A housing of a conventional battery bracket is typically formed from solid or heavily ribbed plastics materials such that there is little or no interior space enclosed by the conventional bracket. Consequently, it is possible to make the bracket housing 17 according to the invention from lighter plastics materials than are typically used for conventional battery position stabilizing brackets and yet still provide an interior space for accommodating the supercapacitor pack 21.

Preferably, the bracket housing 17 has two rows of supercapacitors devices 21A arranged on opposing sides of a central section 28 of the bracket housing 17. The two rows of supercapacitors devices 21A are preferably arranged with their electrical terminals 29 adjacent to or facing the central section 28 of the housing 17.

The central section 28 of the housing 17 preferably accommodates one or more printed circuits boards (PCBs) 30 to which groups of the electrical terminals 29 of the supercapacitor devices 21A are respectively electrically connected. The electrical terminals 29 of the supercapacitor devices 21A may be physically and electrically directly connected to the one or more PCBs 30. The arrangement of the supercapacitor devices 21A physically and electrically directly connected to the one or more PCBs 30 further strengthens the bracket housing 17 and the supercapacitor apparatus 31 which results from the combination of the bracket housing 17 fitted with the supercapacitor pack 21 as described above.

The central section 28 of the bracket housing 17 preferably has a wall 32 extending between the bottom shell (lower cover) 17C and the top shell (upper cover) 17D of the bracket housing 17. The wall 32 further strengthens the bracket housing 17. The wall 32 preferably defines a slot 33 which provides an airflow path 34 through the slot 33 between an exterior space below the bracket housing 17 and an exterior space above the bracket housing 17. The airflow path 34 through the slot 33 preferably extends along a major portion of the longitudinal length of the housing 17. By forming the airflow path 34 through the slot 33 of the wall 32 along a center line of the housing 17 has the advantage that, in the exemplary embodiment of FIG. 2, the airflow pathway 34 of the slot 33 aligns with a gap between some of the batteries 12A of the battery pack 12 enhancing convection cooling of the battery pack compartment 13 and of the supercapacitor apparatus 31 comprising the combination of the bracket housing 17 fitted with the supercapacitor pack 21 in its interior space 20. The internal wall 32 defining the slot 33 and air pathway 34 also strengthens the bracket housing 17 making it suitable to function both as a battery position stabilizer bracket 15 and as a supercapacitor pack 21 for connection to the battery pack 12 to form a combined power source 11 for the vehicle 10.

Further air passageways 35 are provided through the housing 17 aligned with the aperture 17A and extending perpendicularly to the longitudinal center line of the housing 17. It will be seen that, in the exemplary embodiment of FIGS. 2 and 3, the further air passageways 35 coincide with at least one other gap between the batteries 12A in the I-shaped configuration further enhancing convective cooling of the battery pack compartment 13 and the supercapacitor apparatus 31.

The present invention provides a method of extending the life of a battery pack 12 of a vehicle 10 by attaching the bracket 15 to the battery pack compartment 13 such that a surface of the bracket housing 17 contacts a surface of the at least one battery 12A to secure or at least stabilize the position of the at least one battery 12A relative to the battery pack compartment 13; providing a supercapacitor pack 21 in an interior space of the bracket housing 17; and electrically connecting the supercapacitor pack 21 to the battery pack 12.

The invention also provides a method of modifying an existing vehicle 10 having a battery pack 12 accommodated in a battery pack compartment 13 of the vehicle 10, the battery pack 12 having at least one battery 12A, and a bracket for stabilizing a position of the at least one battery 12A in the battery pack compartment 13, the bracket having means 16 for attaching the bracket to the battery pack compartment 13 such that a surface of the bracket contacts a surface of the at least one battery 12A to secure or at least stabilize the position of the at least one battery 12A relative to the battery pack compartment 13; the method comprising: replacing the existing bracket by a modified bracket 15 according to the invention comprising a housing 17 with an interior space, the interior space accommodating a supercapacitor pack 21; and electrically connecting the supercapacitor pack 21 to the battery pack 12. The method of modifying an existing vehicle 10 may comprise replacing a conventional or existing battery bracket with a bracket 15 modified in accordance with the aspects of the invention.

Supercapacitor devices are designed to deliver energy/power very quickly making them excellent complements to batteries. Whilst battery packs can provide typically 10 times more energy over longer periods than supercapacitor packs, supercapacitor packs can typically provide energy at 10 times the speed of battery packs. This makes a combined battery pack and supercapacitor pack power source an ideal power source in applications where short bursts of energy/power are required such as energy/power for generating motive force in electrical and hybrid vehicles.

Delivering energy quickly can put stress on a battery pack which shortens its useful operating life. The combination of the supercapacitor pack with the battery pack removes this stress from the battery pack thereby prolonging the battery pack's useful operating life.

Furthermore, recharging the battery pack induces cyclic stresses that degrade battery electrode materials and electrolyte components which also reduces the battery pack's useful operating life. The combination of the supercapacitor pack with the battery pack reduces the frequency of recharging of the battery pack which further prolongs the battery pack's useful operating life.

The supercapacitor pack provides other advantages in that it can undergo an almost unlimited number of charge/discharge cycles as it stores charge electrostatically. It can also charge very quickly compared to a battery pack to be ready for a next energy/power burst cycle in a very short time period. Consequently, the supercapacitor pack complements the battery pack in more efficient use of stored energy in the combined power source, the reduction of stress on the battery pack thereby prolonging its useful operating lifetime, and the delivery of power in short bursts for accelerating and start-up motion of the vehicle.

The present invention enables an existing vehicle having a battery pack power source to be readily modified to connect one or more supercapacitor packs to the battery pack whilst using space that would otherwise not be used in the vehicle and whilst using space that enables the supercapacitor pack to be easily and conveniently connected to the installed battery pack.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A vehicle comprising:
a power source comprising a battery pack, the battery pack having at least one battery;
a battery pack housing accommodating the battery pack; and
a bracket for stabilizing a position of the at least one battery of the battery pack in the battery pack housing, the bracket having means for attaching the bracket to the battery pack housing such that a surface of the bracket contacts a surface of the at least one battery to secure or at least stabilize the position of the at least one battery relative to the battery pack housing;
wherein the bracket comprises a housing having an interior space, the interior space accommodating a supercapacitor pack, the supercapacitor pack electrically connected to the battery pack.

2. The vehicle of claim 1, wherein the supercapacitor pack is electrically connected to an electrical port provided on the bracket housing and a cable electrically connects the electrical port to the battery pack.

3. The vehicle of claim 1, wherein the interior space of the bracket housing has one or more sections adapted to respectively accommodate one or more supercapacitor devices comprising the supercapacitor pack.

4. The vehicle of claim 3, wherein the one or more sections of the interior space of the bracket housing are each shaped to be complimentary to an outer shape of the one or more supercapacitor devices comprising the supercapacitor pack.

5. The vehicle of claim 4, wherein the outer shape of the one or more supercapacitor devices is cylindrical and the one or more sections of the interior space of the bracket housing are each cylindrically shaped and of a same size as the outer shape of one or more supercapacitors devices.

6. The vehicle of claim 3, wherein the supercapacitor pack comprises a plurality of supercapacitors devices arranged in two rows on opposing sides of a central section, the central section extending along a portion of a longitudinal center line of the bracket housing, the plurality of supercapacitors devices being arranged in the two rows with their electrical terminals adjacent to or facing the central section of the housing.

7. The vehicle of claim 6, wherein the central section of the housing accommodates one or more printed circuits boards to which the electrical terminals of the plurality of supercapacitors devices are electrically connected.

8. The vehicle of claim 6, wherein the electrical terminals of the plurality of supercapacitors devices are directly electrically connected to the one or more printed circuits boards.

9. The vehicle of claim 6, wherein the central section of the bracket housing has a wall extending between a lower cover and an upper cover of the bracket housing with a slot of the wall providing an airflow path between an exterior space below the bracket housing and an exterior space above the bracket housing.

10. The vehicle of claim 9, wherein one or more additional air passageways are provided in the bracket housing aligned with the attachment means and extending in a line normal to the longitudinal center line of the bracket housing.

11. The vehicle of claim 1, wherein the battery pack comprises a plurality of batteries electrically connected in series and the supercapacitor pack is electrically connected to the battery pack in parallel.

12. The vehicle of claim 1, wherein the battery pack comprises six batteries arranged in an “I-shaped” configuration within the battery pack housing, the vehicle including two brackets for stabilizing the positions of the six batteries, at least one of the brackets accommodating a supercapacitor pack electrically connected to the battery pack, each bracket being attached to the battery pack housing such that a lower surface of the bracket housing presses down on portions of upper surfaces of a respective set of three of the batteries to stabilize the position of the set of three batteries relative to the battery pack housing.

13. The vehicle of claim 12, wherein a housing of the at least one of the one of the brackets accommodating the supercapacitor pack sized to fit within a space on the portions of the upper surfaces of the set of three batteries with a maximum size of said space being delimited by positions of vent caps of the set of three batteries.

14. The vehicle of claim 13, wherein the size of the bracket housing accommodating the supercapacitor pack is selected such as to not impede operation of the vent caps of the set of three batteries.

15. The vehicle of claim 1, wherein the vehicle is a golf cart.

16. A bracket for a vehicle having a power source comprising a battery pack accommodated in a battery pack housing, the bracket comprising:
means for attaching the bracket to the battery pack housing of the vehicle such that a surface of the bracket contacts a surface of at least one battery of the battery pack to secure or at least stabilize the position of the at least one battery relative to the battery pack housing; and
a housing having an interior space, the interior space configured to accommodate a supercapacitor pack, the supercapacitor pack electrically connectable to an electrical port provided on the housing, the electrical port enabling the supercapacitor pack to be electrically connected to the battery pack of the vehicle.

17. A supercapacitor pack for a vehicle having a power source comprising a battery pack accommodated in a battery pack housing, the supercapacitor pack comprising:
a housing, said housing having means for attaching the supercapacitor pack to the battery pack housing of the vehicle such that a surface of the housing contacts a surface of at least one battery of the battery pack to secure or at least stabilize the position of the at least one battery relative to the battery pack housing; wherein said housing has an interior space, the interior space accommodating one or more supercapacitor devices comprising the supercapacitor pack, the one or more supercapacitor devices being electrically connected to an electrical port provided on the housing enabling the supercapacitor pack to be electrically connected to the battery pack of the vehicle.

18. A method of extending the life of a battery pack of a vehicle, the battery pack being accommodated in a battery pack housing of the vehicle, the battery pack having at least one battery; the method comprising:
attaching a bracket to the battery pack housing such that a surface of the bracket contacts a surface of the at least one battery to secure or at least stabilize the position of the at least one battery relative to the battery pack housing;
providing a supercapacitor pack in an interior space of the bracket; and
electrically connecting the supercapacitor pack to the battery pack.

19. A golf cart comprising:
a power source comprising a battery pack, the battery pack having a plurality of batteries electrically connected in series;
a battery pack housing accommodating the battery pack; and
one or more brackets for stabilizing positions of the plurality of batteries of the battery pack in the battery pack housing, each bracket having means for attaching the bracket to the battery pack housing such that a lower surface of the bracket presses on portions of upper surfaces of at least two or more of the plurality of batteries to secure or at least stabilize the positions of the at least two or more of the plurality of batteries relative to the battery pack housing;
wherein at least one of the brackets comprises a housing having an interior space, the interior space accommodating a supercapacitor pack, the supercapacitor pack electrically connected in parallel to the battery pack, the supercapacitor pack comprising a plurality of identical supercapacitor devices;
wherein the bracket housing having an interior space accommodating a supercapacitor pack has a plurality of cylindrically shaped sections formed in the interior space to respectively accommodate the supercapacitor devices, the sections in the interior space of the bracket housing being shaped to be complimentary to a cylindrical outer shape of the supercapacitor devices and of a same size as the cylindrical outer shape of the supercapacitor devices; and
wherein the bracket housing having an interior space accommodating a supercapacitor pack is sized to fit within a space on the portions of the upper surfaces of the at least two or more of the plurality of batteries where a maximum size of said space is delimited by positions of vent caps on the upper surfaces of the at least two or more of the plurality of batteries.
